(19) United States
(12) Patent Application Publication
(10) Pub. No.: US 2007/0100982 A1
(43) Pub. Date: May 3, 2007

(54) Methods and apparatus for communicating information in a network

(76) Inventor: Bhaskar Jayaraman, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/489,579

(22) Filed: Jul. 20, 2006

(30) Foreign Application Priority Data
Oct. 31, 2005 (IN) IN2899/DEL/2005

(51) Int. Cl. G06F 15/173

(52) U.S. Cl. 709/223

(57) ABSTRACT

Methods for communicating parameterised information between entities which in, at least, one embodiment comprise a method of specifying the state of a node in a network comprising the steps of: defining n parameters Aᵢ={A₁, A₂ . . . Aₙ}, where i=(1,n), which specify the state S of the node; defining a m row by n column matrix [B_{m,n}] where each parameter Aᵢ corresponds to a range of m values B_{j,i} where j=(1,m), wherein the values B_{j,i} are prime numbers selected and arranged so that the state S can be uniquely represented by the product P of n primes B_{j,1}, B_{j,2} . . . B_{j,n}, where j=(1,m).

### RELATED APPLICATINS

The present application is based on, and claims priority from India Application Number 2899/Del/2005, filed Oct. 31, 2005, the disclosure of which is hereby incorporated by reference herein in its entirety.

### BACKGROUND TO THE INVENTION

In the operation and administration of networks, it is important that the state of the network can be maintained and accurately analysed. Such network management or administration functionality is required to maintain the resources, communications and overall operation of the network. One aspect of network management is the analysis of discrete network resources, hereafter referred to as nodes. This involves communicating of the state of the nodes between the nodes and the management hardware and between the nodes themselves.

Several methods exist for representing and monitoring the state of a network, in particular the nodes of a network including representing the state of the network based on node state parameters such as cost, performance, traffic and bandwidth. This data needs to be communicated across the network, either by the nodes themselves or by network management nodes charged with managing and maintaining the network.

The skilled reader will appreciate that this preamble and description is, for brevity, an oversimplification in respect of network management techniques. However, at a high level of abstraction, the ability to express the state of a network and communicate this information across the network is a significant issue. Such techniques need to be efficient in terms of information transport mechanism so that the management overhead of communicating network state information for administration purposes does not significantly affect or impair the performance of the network as a whole. Known techniques are generally based on the determination and communication of full state information about the network nodes. For example, a network management node may ‘collect’ information about the individual nodes constituting the network including CPU state, memory, bandwidth, load etc. Thus, a complete parameterisation of each node is performed and it is therefore necessary that a complete data set describing the state of each node is transmitted over the network. It would be advantageous to provide a method and apparatus which reduces the load caused by communicating the node state data across the network while preserving the ability to specify the node state in full, unambiguously and with precision.

Furthermore, efficient information transport across a network usually involves some form of arbitration. Arbitration techniques are used to determine the most efficient data path through the network based on the network state. This usually depends closely on the individual node state of the network and is evaluated on the bases of one or more node characterisation parameters by which the cost of information transport is to be measured.

### BRIEF DESCRIPTION OF THE DRAWINGS

Embodiments of the invention will now be described by way of example only with reference to the drawings in which:

FIG. 1: illustrates a schematic of a cluster network;

FIG. 2: illustrates detail of the network shown in FIG. 1; and

FIG. 3: illustrates an embodiment where a parent node state includes contributions from a plurality of child nodes.

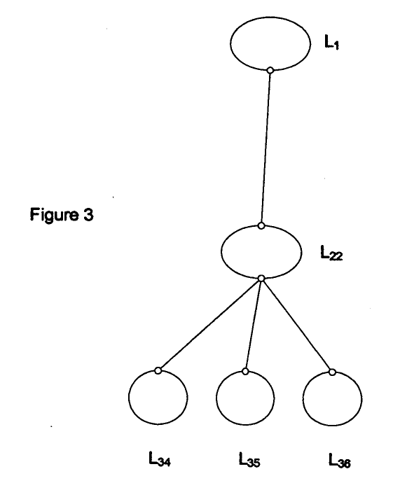

### DETAILED DESCRIPTION OF THE INVENTION

There will be described a method of specifying the state of a node in a network, comprising the steps of:
defining n parameters Aᵢ={A₁, A₂ . . . Aₙ}, wherei=(1,n), which specify the state S of the node; and
defining a m row by n column matrix [B_{m,n}] where each parameter Aᵢ corresponds to a range of m values B_{j,i} where j=(1,m), wherein the values B_{j,i} are prime numbers selected and arranged so that the state S can be uniquely represented by the product P of n primes, where j=(1,m).

In this way, the state of a node can be uniquely expressed by means of a number which, based on knowledge of the encoding technique and exploiting the factorisation properties of natural numbers allows the information required to be communicated across a network to be substantially reduced while still fully specifying the node state in an unambiguous manner.

The range of m values B_{j,i} where j=(1,m), may represent numerical or percentage values of the parameter Aᵢ.

Preferably the values B_{j,i} correspond to sequential prime numbers read in row order.

There will also be described a method of determining the state S of a node in a network based on an a priori knowledge of a predetermined m by n prime number matrix representation of parameter information constituting one or more states, comprising the steps of:
factorising a product P representing said state S into n prime numbers;
determining which matrix values B_{j,i} said prime numbers correspond to;
correlating the matrix values of B_{j,i} to corresponding parameters Aᵢ, where j=(1,m), and
expressing the state S in terms of parameters Aᵢ.

In preferred embodiments, j represents the granularity of the parameter being measured.

B_{j,i} are preferably prime numbers such that no two prime numbers in the m row by n column matrix are equal. In preferred embodiments, the values B_{j,i} are sequential prime numbers read in row order.

The parameters may correspond to physical attributes of the nodes including CPU power, memory capacity, network bandwidth capacity, processor type and similar.

Where the technique is applied to an homogeneous network, the parameters may include CPU capacity, memory capacity, and network bandwidth capacity. In an heterogeneous network, the parameters may include a processor type parameter which is used to represent the type of processor or architecture which is running on the node whose state is being communicated.

In the case where the parameters include the processor type, corresponding values may be data strings corresponding to specific processor or machine types.

Preferably, each node in the network maintains a first routing data table containing information relating to the parameter values of said node wherein the information is used to route data between the nodes.

In an alternative embodiment, the invention provides a method of specifying the state of a parent node in a network as hereinbefore defined, wherein the state additionally includes contributions from plurality of child nodes below said parent node, wherein the contributions from the child nodes include parameters which correspond to average values of the parameters specifying the state of each of the child nodes.

Preferably, each parent node in the network also maintains a second routing data table containing information relating to the parameter values of the child nodes beneath that parent node wherein the information is used to route data between the nodes.

The state of a parent node so described may therefore include contributions from a plurality of child nodes and the parent node itself.

In this case, a node in the network may maintain a plurality of routing data tables including information relating to the state of any child nodes below that node and the node itself.

Communication of a node state between any pair of nodes may be effected in accordance with the methods described above.

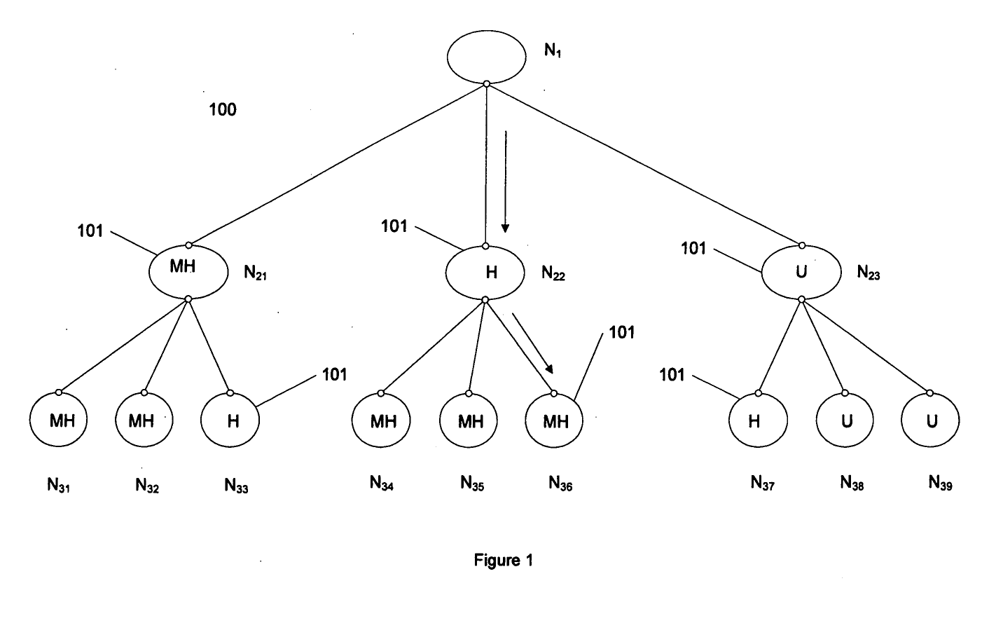

Referring to FIG. 1, a simplified cluster network 100 is shown comprising a plurality of nodes 101. The data is consistent across the nodes N₃₁ to N₃₉. That is, for simplicity and ease of illustration, the nodes N₃₁ to N₃₉ store the same data which is sought to be communicated across the network. This means that for the purposes of obtaining the desired data, each node is a potential candidate for participating in the data transfer. The nodes 101 in FIG. 1 are shown as generalised elements or components of the network.

In one embodiment, the nodes may correspond to computing resources including one ore more central processing units (CPUs), memory, network interfaces and other supporting hardware. In the embodiment illustrated and described, the network implements the TCP/IP protocol for data transport across the fabric of the network. Other network protocols may be suitable as it is envisaged that the specifics of the actual data transport mechanism or protocol are not important. Also, in this particular embodiment it is assumed that all of the nodes in the network are physically equivalent (i.e.; a homogeneous network) in that they may be compared in terms of similar parameters, specifically in respect of comparing percentage CPU capacity etc.

This is a special case of the technique disclosed and is discussed in this form for clarity. Heterogeneous networks will be discussed below.

Retrieving data at node N₁ contemplates three potential logical paths. The first is from the cluster N₃₁-N₃₃ to N₂, and then to N₁. The second is from the group N₃₄-N₃₆ to N₂₂ and then N₁ and the last is group N₃₇-N₃₉ to N₂₃ and then to N₁. All other matters being equal, the determination of the best path is based upon the state of the node.

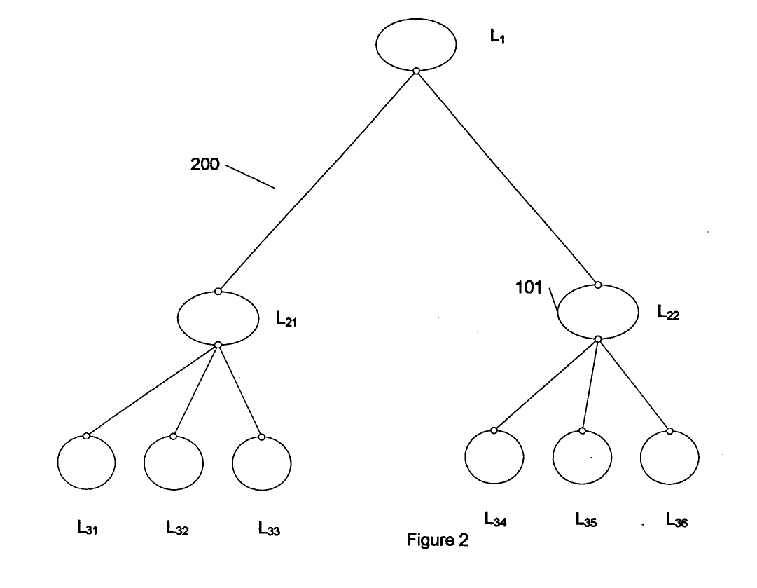

Each node has a different “health” indicated by H (healthy), MH (moderately healthy) and U (unhealthy). This information is stored in each node in a data routing table and is transmitted from each node to its parent node. Each node can decide from which of its child nodes it should request the required data by choosing among the healthiest of its children. In the example shown in FIG. 1, the data will be most efficiently requested by N₁ from N₂₂ and N₂₂ will in turn request the data from N₃₆. The illustrated “health” parameter is intended to be a simplification and is meant to represent the efficiency of the node in handling network traffic.

Where previously a node had been qualitatively assessed in terms of its “health”, in a quasi-homogeneous or homogeneous network, such as that shown in FIG. 1, each node can be more accurately considered as occupying a ‘state’. The node state represents quantitative and/or qualitative characteristics of the node and may be specified, or parameterised, by one or more parameters which relate to various aspects of the functionality of the node. For example, in the case of a node in the form of a computer connected to the network, we can specify its state using three parameters: processor load (CPU), memory usage (MEM) and network bandwidth (N/W). Of course more complex state parameterisations are possible including specific CPU power, type and capacity of memory available as well as performance suitability for a specific task for example. However, for brevity and clarity, the following description will contemplate only these three parameters. The parameters will generally be independent. However, in alternative variants it is possible that there may be a degree of coupling between the specific node state parameters. For brevity, we will also only consider what may be considered to be the more important node state parameters for a simplified quasi-homogeneous network such as that shown in FIGS. 1 and 2.

Referring to FIG. 2, a more detailed portion 200 of the network 100 is shown, in this case, the two leftmost branches under nodes N₂₁ and N₂₂. We assume a network tree of three levels L₁, L₂ and L₃ with the nodes at level 1, or the root node,=L₁, the nodes at level 2=L₂₁, L₂₂ and the nodes at level three=L₃₁, L₃₂ . . . L₃₆.

The state of each node is specified by the three parameters described above: {CPU, MEM, N/W}. Each node 101 monitors its own three parameters and these three parameters are used to characterise that nodes state for the purposes of arbitrating which network path is the most efficient for routing data across the network. Alternatively, in other embodiments, this information may be used to determine which node is able or most suitable for use for certain tasks. This latter function, for example, is relevant to the management and operation of computational grids.

Each node 101, monitors its parameters and reports its state to a parent node at a higher level. Each node at the higher level is assumed to have knowledge of the state representation schema according to the invention including the specific parameter mapping used by the node at its immediate lower (child) level. The node need not know the state of nodes at the other levels except for the child node and itself.

At a general level, the state of a node in a network is specified according one embodiment of the present technique as being a method comprising the steps of:
defining n parameters Aᵢ={A₁, A₂ . . . Aₙ} where i=(1,n) which specify the s tate S of the node;
defining a m row by n column matrix [B_{m,n}] where each parameter Aᵢ corresponds to a range of m values B_{j,i}, where j=(1,m), wherein the values B_{j,i} are prime numbers selected and arranged so that the state S can be uniquely represented by the product P of n primes B_{j,1}, B_{j,2} . . . B_{j,n}, where j=(1,m).

In the example shown in FIG. 2, n=3 and the parameter set Aᵢ={CPU, MEM, N/W} which corresponds to the state S of each node.

If we consider any of the nodes at level three, an array, or matrix, of prime numbers is generated to represent the various states that each node in level can occupy. For three parameters, a general matrix can be constructed:

$$[ \begin{matrix}Row no . & {A}_{1} & {A}_{2} & {A}_{3} \\ R 1 & {B}_{11} & {B}_{12} & {B}_{13} \\ R 2 & {B}_{21} & {B}_{22} & {B}_{23} \\ R 3 & {B}_{31} & {B}_{32} & {B}_{33}\end{matrix} ]$$

In the present example, the matrix is therefore:

$$[ \begin{matrix}Row no . & CPU & MEM & N / W \\ R 1 & 3 & 5 & 7 \\ R 2 & 11 & 13 & 17 \\ R 3 & 23 & 29 & 31\end{matrix} ]$$

The first row and first column are included for clarity only and are not necessary for the node state specification/schema other than to indicate which particular physical parameter that the matrix entries correspond to. The first column of matrix entries {3, 11, 23} are used to specify the first parameter value of A₁ (CPU). Similarly, the second column of matrix entries {5, 13, 29} are used to specify the second parameter A₂ (MEM) values and similarly for the third column of matrix entries. The subscript j indicates that each state parameter {CPU, MEM, N/W} is specified by a single parameter value from each corresponding column—that is, a single value of CPU, MEM and N/W. This means that the parameters {CPU, MEM, N/W} can only assume values from their corresponding matrix columns.

For any parameter value column, each row of that column corresponds to a representation of the ‘usage’ of its corresponding column. That is, each parameter is divided into increments having a size=row number/number of rows. This corresponds to a measure of the relative capacity of the parameter and thus it can be seen, for a quasi-homogeneous or homogeneous network, the parameters need to be equivalent or at least able to be compared in a relative way to allow proper arbitration between nodes.

For example, as shown above the CPU parameter values are divided into three ranges and expressed as maximum percentages 33%, 66% and 100% of the total CPU power available. For example, R1 represents 0-33% CPU usage, R2 34% -66% CPU usage etc. Following this level of parameter granularity, all CPU usage values for 0 to 33% will be represented by the prime number appearing in the first row (R1) under the CPU column—i.e.; 3. For node memory (MEM) capacity corresponding to 80% usage, this will be represented by the prime number appearing in the third row under the matrix column for MEM—i.e.; 29. Thus all of the physical values of the parameters are divided into ranges representing a granularity of 33%. i.e.; 0-33%, 34% -66%, and 67% -100%.

The capacity resolution indicated by the number of rows in the matrix is arbitrary and governed by the desired granularity j of the parameter which is sought to be measured and communicated between the nodes. In the case described herein, we have assumed a subdivision of the measured parameters into thirds expressed as a percentage of the total capacity. The granularity could be increased by including, for example, 100 rows, each corresponding to a 1% resolution in the parameter which is being specified. This would require the generation of a larger parameterisation matrix, but may be desirable in alternative embodiments. In general all nodes at the same level use the same granularity j. The reason for this will be discussed below in the context of multiple child nodes contributing to the state/capacity of a parent node.

The parameter specification can be formally represented by a function:
F (row)=fl (product, parameter, tablesize).

For example, consider encoding a state using the prime triplet 3×5×7=105 The actual value of the CPU capacity is indicated by the row number and can be expressed as fl(105, CPU, 3). Thus the function indicates that the parameter considered is the CPU capacity, the transmitted product is 105 and the resolution or granularity of the CPU capacity measurement is ⅓ or 33%. The definition of this function is largely a matter of formalism and other ways of specifying the encoding schema are possible within the scope of the invention.

For example, if it is assumed that node L₃₁ operates at the following capacity:

| | |
|---|---|
| CPU: | 42% |
| MEM: | 23% |
| N/W: | 72% |

This node can be represented by the matrix values:

| | |
|---|---|
| CPU: | 11 |
| MEM: | 5 |
| N/W: | 31 |

Hence the product, which will represent the node state, will be:
11×5×31=1705

Thus, it is sufficient that the leaf node L₃₁ transmit only this number over the network to its parent node to completely specify its state. When the parent node L₂₁ receives this number, it can determine the state of the child node L₃₁ by performing a prime factorisation to give the primes 11, 5 and 31. This triplet, coupled with knowledge of the structure and rules (schema) specifying the matrix along, including the location of the primes in the matrix, uniquely identifies the actual parameter values which have been communicated. For example, the parent node will look for the prime number 5 in the matrix and determine that this corresponds to 0-33% memory usage, for prime number 11, this will correspond to 34% -66% CPU usage and prime number 31 will correspond to a network bandwidth capacity of 67-100% of total capacity. The order of the prime factorisation is immaterial as the position of the primes in the matrix is known by the parent node and the triplet is thus unambiguous. As noted above, the granularity or resolution of the parameter is selected as required and in this case is a division into thirds of the total parameter value.

In the embodiment described above, the state of each node is specified according to a triplet (product) of primes giving a single number. This single number can be efficiently communicated between a child node and a parent node thereby reporting the state of the child node to its parent which parent being then able to use this information to arbitrate data flow between one or more child nodes. The parent node does this using prime factorisation whereby the prime triplet product is uniquely factorised to obtain the original three primes used in the matrix to obtain the number. Thus, armed with knowledge of the encoding schema (the number and type of the parameters used to specify the node states etc) and the ability to factorise the single number which is communicated to it, a parent node can determine the network capacity of each child node immediately below it and this effectively arbitrate between difference network paths.

The above example has considered the communication of a child node state to its parent where it is assumed that the child node state reflects solely the child node's own physical characteristics and that the parent can then arbitrate between a plurality of child nodes at the same level which are reporting their state in this way. However, a more common scenario is where a node has a capacity which includes contributions from a plurality of child nodes below it. This situation is shown by node L₂₁ which has three child nodes below it L₃₁ , L₃₂ and L₃₃. In this situation, the state of L₂₁ as seen by L₁ includes contributions from L₂₁s child nodes as well as L₂₁ itself.

In this situation we need to consider how to completely specify the state of L₂₁ and communicate that state to L₁.

At the broadest level, this is done by calculating an effective value of each of the node parameters which need to be reported to the parent node L₁. This is done by taking an average of the child state parameters below L₂₁. In effect this means that, from the point of view of L₂₁, the three child nodes are treated as a single node which will contribute to the capacity of L₂₁.

Following the technique described above, each child node L₃₁, L₃₂ and L₃₃ encodes its parameters and communicates them to the node L₂₁. This may be done at the same level of granularity as used when L₂₁ reports to L₁. However, a finer level of granularity may be used if desired. Once decoded by the node L₂₁ in accordance with the specified schema and the prime factorisation theorem, this information is stored in data routing tables in L₂₁ and is used to arbitrate between the child nodes L₃₁, L₃₂ and L₃₃ when L₂₁ is itself called on to route traffic between the three child nodes.

The parameter information is averaged and transformed, if necessary, into a granularity which conforms to the node L₂₁s own specification schema/matrix. This value is then averaged with L₂₁'s own parameters and encoded according to the matrix schema and transmitted to L₁ as a whole number. L₁ factorises this number into a prime triplet and decodes the capacity presented by L₂₁. Thus L₁ ‘sees’ only the complete capacity offered by L₂₁ which includes the contributions from each of the child nodes below L₂₁. Thus, the technique disclosed here takes into account the effect of child nodes in the network tree and thus can be used to reduce the amount of data which must be communicated between network nodes in cases of multi-level tree structures.

The previous discussion has generally assumed that the parameters defining the node state are able to be consistently applied across the network. In the case of a heterogeneous network, this may not be possible without communicating information about the specific characteristics of the nodes in question. In a heterogeneous network, one or more parameters may be used to specify, for example, the CPU type in cases where the primary heterogeneity between nodes is caused by processing power variation. Here, the processor type parameter may be specified and communicated in accordance with the method set out above with suitable adaptation in the definition of the prime schema matrix. Thus, differing processor capacities may be taken into account when load balancing or determining contention between nodes for data transmission. Similarly, other machine specific variations such as memory capacity etc may be taken into account when specifying a node state. The specific implementation of these aspects is considered within the purview of the skilled person.

Thus, it can be seen that the above described technique provides a mechanism by which the bandwidth requirements for communicating parameterised data can be significantly reduced. Furthermore, aside from the aforementioned applications relating to network management, the techniques described may find application in other contexts such as load balancing and sensing technologies where specific sensed parameters need to be transmitted over bandwidth-constrained data links.

Other varied applications of the technique disclosed may include such diverse contexts as network gaming where typically the operation of such a game uses a highly specific parameterisation to specify the progress of the game and the characteristics and interaction of its players. In particular, massively multiplayer games may use the techniques to communicate this information amongst large numbers of player nodes and the administration nodes thereby reducing the bandwidth overhead.

Further applications related to remote sensing may also include telemetry in a variety of forms. For example, a plurality of specific predetermined parameters are sought to be communicated—usually from a remote location to an analysis location. As in the other applications, these contexts may benefit from the node specification/determination technique according to the various embodiments of the present technique and can thus reduce their bandwidth requirements accordingly.

Where in the foregoing description reference has been made to integers or elements having known equivalents, then such equivalents are herein incorporated as if individually set forth.

1. A method of specifying the state of a node in a network, comprising the steps of:
defining n parameters Aᵢ={A₁, A₂ . . . Aₙ}, wherei=(1,n), which specify the state S of the node; and
defining a m row by n column matrix [B_{m,n}] where each parameter Aᵢ corresponds to a range of m values B_{j,i} where j=(1,m), wherein the values B_{j,i} are prime numbers selected and arranged so that the state S can be uniquely represented by the product P of n primes B_{j,1}, B_{j,2} . . . B_{j,n}, where j=(1,m).

2. A method of determining the state S of a node in a network based on an a priori knowledge of a predetermined m by n prime number matrix representation/schema of parameter information constituting one or more states, comprising the steps of:
factorising a product P representing said state S into n prime numbers;
determining which matrix values B_{j,i} said prime numbers correspond to;
correlating the matrix values of B_{j,i} to corresponding parameters Aᵢ, where j=(1,m); and
expressing the state S in terms of parameters Aᵢ.

3. A method as claimed in claim 1 wherein the range of m values B_{j,i} where j=(1,m), represent numerical values of the parameter Aᵢ.

4. A method as claimed in claim 1 wherein, the range of m values B_{j,i}, where j=(1,m), represent percentage values of the total value of parameter Aᵢ.

5. A method as claimed in claim 1 wherein the values B_{j,i} correspond to sequential prime numbers read in row order.

6. A method claimed in claim 1 wherein, j represents the granularity of the parameter being measured.

7. A method claimed in claim 1 wherein B_{j,i} correspond to prime numbers such that no two prime numbers in the m row by n column matrix are equal.

8. A method as claimed in claim 1 wherein the parameters correspond to physical attributes of the nodes selected from the group comprising CPU power, memory capacity, network bandwidth capacity, processor type and similar.

9. A method of as claimed in claim 1, wherein for a homogeneous network, the parameters are selected from the group comprising CPU capacity, memory capacity, and network bandwidth capacity.

10. A method claimed in claim 1 wherein, the parameters comprise a processor type parameter which is used to represent the type of processor or architecture which is running on the node whose state is being communicated.

11. A method claimed in claim 10 wherein the processor type information may be one or more data strings corresponding to or identifying a specific processor or machine type.

12. A method as claimed in claim 1 wherein each node in the network maintains a first routing data table containing information relating to the parameter values of said node, wherein the information is used to route data between the nodes.

13. A method of specifying the state of a parent node in a network according to the method of claim 1, wherein the state additionally includes contributions from a plurality of child nodes below said parent node, wherein the contributions from the child nodes include parameters which correspond to average values of the parameters specifying the state of each of the child nodes.

14. A method as claimed in claim 13 wherein each parent node in the network also maintains a second routing data table containing information relating to the parameter values of the child nodes beneath that parent node wherein the information is used to route data between the nodes.

15. A method of specifying the state of a parent node in a network as claimed in claim 13 wherein the state of a parent node includes contributions from a plurality of child nodes and the parent node itself.

16. A method of communicating information relating to a node state between any pair of nodes in a network wherein the information is specified according to the method as claimed in claim 1.

17. A method of communicating parameterised data from a first entity to a second entity, each entity considered to be a node, said first node state being specified by a method comprising the steps of: defining n parameters Aᵢ={A₁, A₂ . . . Aₙ}, wherei=(1,n), which specify the state S of the node; and defining a m row by n column matrix [B_{m,n}] where each parameter Aᵢ corresponds to a range of m values B_{j,i} where j=(1,m), wherein the values B_{j,i} are prime numbers selected and arranged so that the state S can be uniquely represented by the product P of n primes B_{j,1}, B_{j,2} . . . B_{j,n}, where j=(1,m), and the second node state determining the first node state by method comprising the steps of: factorising a product P representing said state S into n prime numbers; determining which matrix values B_{j,i} said prime numbers correspond to; correlating the matrix values of B_{j,i} to corresponding parameters Aᵢ, where j=(1,m ); and expressing the state S in terms of parameters Aᵢ.

18. A network adapted to operate in accordance with claim 1.

19. A node configured to operate in accordance with claim 1.

20. A method as claimed in claim 1 wherein the parameterised data comprises one of load-balancing data, network gaming data, data collection data, telemetry data or communication data.
